(19) United States
(12) Patent Application Publication
(10) Pub. No.: US 2010/0192577 A1
(43) Pub. Date: Aug. 5, 2010

(54) SYSTEM AND METHOD FOR REDUCING COMBUSTION DYNAMICS IN A TURBOMACHINE

(75) Inventors: Kapil Kumar Singh, Rexford, NY (US); Vasanth Srinivasa Kothnur, Clifton Park, NY (US); Fei Han, Clifton Park, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/363,955

(22) Filed: Feb. 2, 2009

(51) Int. Cl. F02C 7/24; F02C 7/22

(52) U.S. Cl. 60/725; 60/737; 60/772

(57) ABSTRACT

A turbomachine includes a combustion chamber, and at least one pre-mixer mounted to the combustion chamber. The at least one pre-mixer includes a main body having a first end portion that extends to a second end portion. The first end portion is configured to receive an amount of fuel and an amount of air and the second end portion defines an exit plane from which a fuel-air mixture discharges into the combustion chamber. The turbomachine also includes a combustion dynamics reduction system operatively coupled to the at least one pre-mixer. The combustion dynamics reduction system includes at least one of a boundary layer perturbation mechanism and an acoustic wave introduction system which disrupt a flow pattern of the fuel-air mixture within the at least one pre-mixer.

### BACKGROUND OF THE INVENTION

The subject matter disclosed herein relates to the art of turbomachines and, more particularly, to a system and method for reducing combustion dynamics in a turbomachine.

Combustion dynamics are a phenomenon in gas turbomachines utilizing lean pre-mixed combustion. Combustion dynamics include low-frequency, longitudinal dynamics and high-frequency screech caused by the excitation of radial and azimuthal modes of the combustion chambers by the swirling flames. Both the low and high frequencies include a combustion field component and an acoustic component, that pass along the combustor during combustion. Under certain operating conditions, the combustion component and the acoustic component couple to create both low and high frequency dynamic fields. The low and high frequency dynamic fields have a negative impact on various turbomachine components. More specifically, dynamic fields passing from the combustor may lead to high cycle fatigue (HCF) for downstream turbomachine components.

To address this problem, turbomachines are operated at less than optimum levels, i.e., certain operating conditions are avoided in order to avoid circumstances that are conducive to combustion screech. While effective at reducing combustion dynamics, avoiding these operating levels restricts an overall operating envelope of the turbomachine.

Another approach to the problem of combustion dynamics is to modify combustor input conditions. More specifically, fluctuations in fuel-air ratio are known to cause combustion dynamics that lead to combustion screech. Creating perturbations in the fuel-air mixture by changing fuel flow rate can disengage the combustion field from the acoustic field to suppress combustion screech. While both of the above approaches are effective at reducing combustion dynamics, avoiding various operating levels restricts an overall operating envelope of the turbomachine while manipulating the fuel-air ratio requires a coupled control scheme and may also lead to less than efficient combustion.

### BRIEF DESCRIPTION OF THE INVENTION

According to one aspect of the invention, a turbomachine includes a combustion chamber, and at least one pre-mixer mounted to the combustion chamber. The at least one pre-mixer includes a main body having a first end portion that extends to a second end portion. The first end portion is configured to receive an amount of fuel and an amount of air and the second end portion defines an exit plane from which a fuel-air mixture discharges into the combustion chamber. The turbomachine also includes a combustion dynamics reduction system operatively coupled to the at least one pre-mixer. The combustion dynamics reduction system includes at least one of a boundary layer perturbation mechanism and an acoustic wave introduction system which disrupt a flow pattern of the fuel-air mixture within the at least one pre-mixer.

According to another aspect of the invention, a method of reducing combustion dynamics in a turbomachine includes directing a fuel-air mixture through a pre-mixer into a combustion chamber, and reducing combustion dynamics by disrupting a flow pattern of the fuel-air mixture within the at least one pre-mixer.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial, cross-sectional side view of a turbomachine including a combustion dynamics reduction system in accordance with exemplary embodiments of the invention;

FIG. 2 is a cross-sectional side view of a combustor portion of the turbomachine of FIG. 1;

FIG. 3 is a schematic view of an injection nozzle assembly including a combustion dynamics reduction system in accordance with one exemplary aspect of the invention;

FIG. 4 is a schematic view of an injection nozzle assembly including a combustion dynamics reduction system in accordance with another exemplary aspect of the invention; and

FIG. 5 is a schematic view of an injection nozzle assembly including a combustion dynamics reduction system in accordance with yet another exemplary aspect of the invention.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a centerbody of a burner tube assembly. The terms “radial” and “radially” as used in this application refer to directions and orientations extending substantially orthogonally to the center longitudinal axis of the centerbody. The terms “upstream” and “downstream” as used in this application refer to directions and orientations relative to an axial flow direction with respect to the center longitudinal axis of the centerbody.

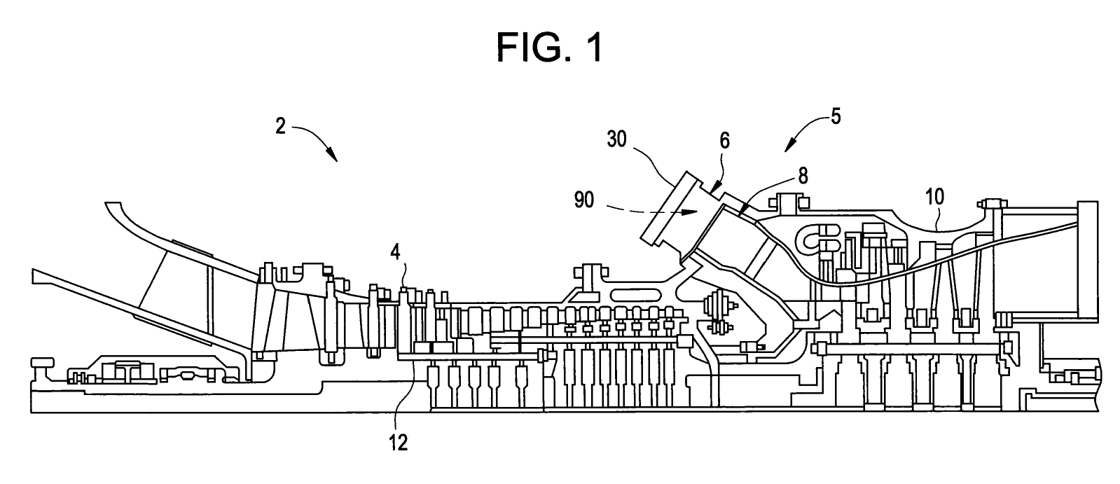

With initial reference to FIG. 1, a turbomachine constructed in accordance with exemplary embodiments of the invention is generally indicated at 2. Turbomachine 2 includes a compressor 4 and a combustor assembly 5 having at least one combustor 6 provided with an injection nozzle assembly housing 8. Turbomachine 2 also includes a turbine 10 and a common compressor/turbine shaft 12. In one exemplary embodiment, turbomachine 2 is a PG9371 9FBA Heavy Duty Gas Turbine Engine, commercially available from General Electric Company, Greenville, S.C. Notably, the present invention is not limited to any one particular engine and may be used in connection with other turbomachines.

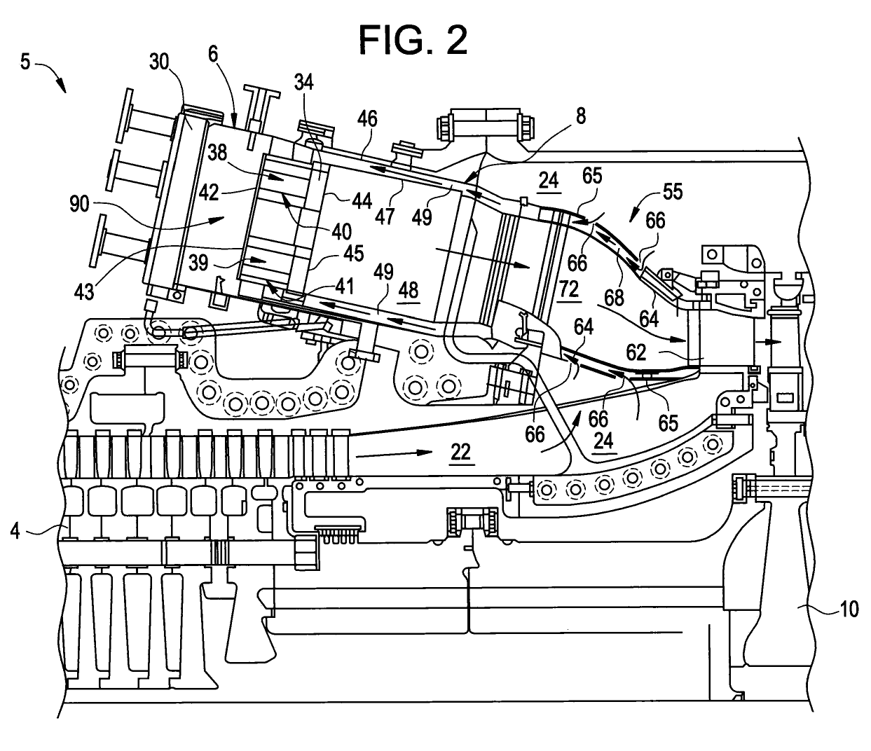

As best shown in FIG. 2, combustor 6 is coupled in flow communication with compressor 4 and turbine 10. Compressor 4 includes a diffuser 22 and a compressor discharge plenum 24 that are coupled in flow communication with each other. Combustor 6 also includes an end cover 30 positioned at a first end thereof, and a cap member 34. Combustor 6 further includes a plurality of pre-mixers or injection nozzle assemblies, two of which are indicated at 38 and 39. Each injection nozzle assembly 38, 39 includes a corresponding main body 40, 41 having first and second end portions 42, 43 and 44, 45 respectively. Second end portions 44 and 45 define an exit plane (not separately labeled) of injection nozzle assemblies 38 and 39 respectively. In addition, combustor 6 includes a combustor casing 46 and a combustor liner 47. As shown, combustor liner 47 is positioned radially inward from combustor casing 46 so as to define a combustion chamber 48. An annular combustion chamber cooling passage 49 is defined between combustor casing 46 and combustor liner 47. Combustor 6 is coupled to turbomachine 2 through a transition piece 55. Transition piece 55 channels combustion gases generated in combustion chamber 48 downstream towards a first stage turbine nozzle 62. Towards that end, transition piece 55 includes an inner wall 64 and an outer wall 65. Outer wall 65 includes a plurality of openings 66 that lead to an annular passage 68 defined between inner wall 64 and outer wall 65. Inner wall 64 defines a guide cavity 72 that extends between combustion chamber 48 and turbine 10.

During operation, air flows through compressor 4, is compressed, and passed to combustor 6 and, more specifically, to injector assemblies 38 and 39. At the same time, fuel is passed to injector assemblies 38 and 39 to mix with the compressed air to form a combustible mixture. The combustible mixture is channeled to combustion chamber 48 and ignited to form combustion gases. The combustion gases are then channeled to turbine 10. Thermal energy from the combustion gases is converted to mechanical rotational energy that is employed to drive compressor/turbine shaft 12.

More specifically, turbine 10 drives compressor 4 via compressor/turbine shaft 12 (shown in FIG. 1). As compressor 4 rotates, compressed air is discharged into diffuser 22 as indicated by associated arrows. In the exemplary embodiment, a majority of the compressed air discharged from compressor 4 is channeled through compressor discharge plenum 24 towards combustor 6. Any remaining compressed air is channeled for use in cooling engine components. Compressed air within discharge plenum 24 is channeled into transition piece 55 via outer wall openings 66 and into annular passage 68. The compressed air is then channeled from annular passage 68 through annular combustion chamber cooling passage 49 and to injection nozzle assemblies 38 and 39. The fuel and air are mixed to form the combustible mixture. The combustible mixture is ignited to form combustion gases within combustion chamber 48. Combustor casing 47 facilitates shielding combustion chamber 48 and its associated combustion processes from the outside environment such as, for example, surrounding turbine components. The combustion gases are channeled from combustion chamber 48 through guide cavity 72 and towards turbine nozzle 62. The hot gases impacting first stage turbine nozzle 62 create a rotational force that ultimately produces work from turbomachine 2. At this point it should be understood that the above-described construction is presented for a more complete understanding of exemplary embodiments of the invention.

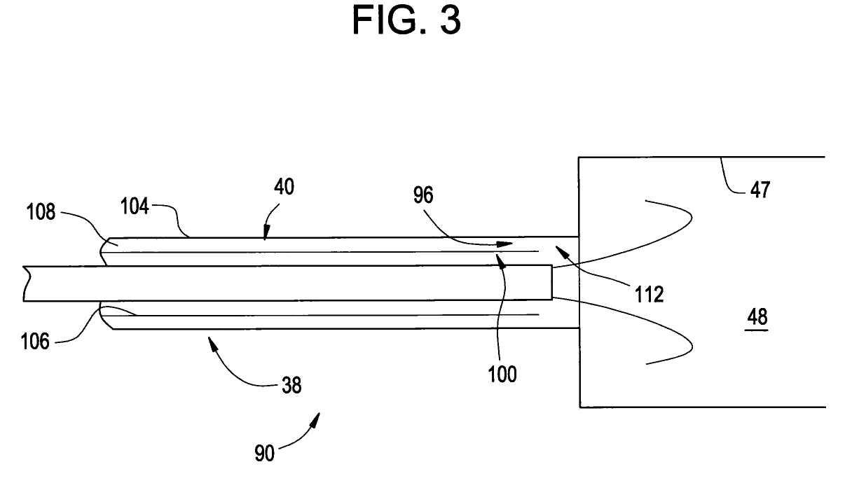

As best shown in FIG. 3, turbomachine 2 includes a combustion dynamics reduction system 90. In accordance with one exemplary embodiment, combustion dynamics reduction system 90 includes a boundary layer perturbation mechanism 96 shown in the form of an air/inert injection system 100. More specifically, injection nozzle assembly 38 includes an outer conduit 104 and an inner conduit 106 between which is defined a passage 108 having an inlet (not separately labeled). Passage 108 has an outlet or opening 112 arranged at second end portion 44 of injection nozzle assembly 38. With this arrangement, air/inert is injected into passage 108 and guided toward second end portion 44. The air/inert passes through opening 112 towards the exit plane of injection nozzle assembly 38. The air creates a disruption or disturbance at a boundary layer between a flame present at the exit plane and the unignited combustible mixture. More specifically, the air/inert disrupts flow patterns of the fuel-air mixture within injection nozzle assembly 38. By controlling air/inert flow rate through passage 108, air/inert injection system 100 alters out vortex shedding behavior at the boundary layer present at the base portion of the flame. The disruption of the boundary layer and vortex characteristics de-couples a combustion field component and an acoustic component present at second end portion 44 in order to suppress any attendant combustion screech.

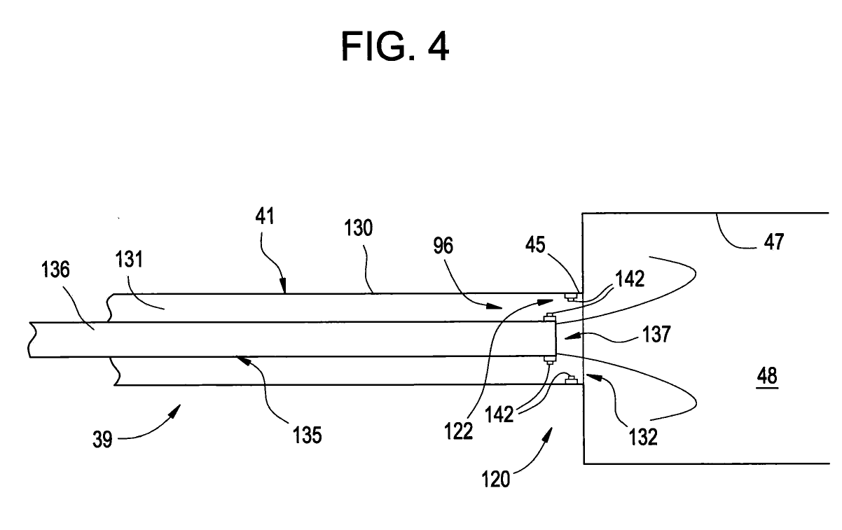

Reference will now be made to FIG. 4 in describing a boundary layer perturbation mechanism 120 in accordance with another exemplary embodiment. As shown, boundary layer perturbation system 120 includes a plurality of mechanical members 122 arranged at second end portion 45 of injection nozzle assembly 39. In a manner similar to that described above, injection nozzle assembly 39 includes an outer conduit 130 having an inner passage 131 that leads to a discharge portion 132 provided at second end portion 45. Injection nozzle assembly 39 also includes an inner conduit 135 having an internal passage 136 that leads to a discharge section 137 also arranged adjacent second end portion 45. With this arrangement, the plurality of mechanical members 122 are arranged on inner surfaces (not separately labeled) of outer conduit 130 as well as outer surfaces (not separately labeled) of inner conduit 135. In accordance with one aspect of the exemplary embodiment, the plurality of mechanical members take the form of protrusions 142. However, mechanical members 122 could also take the form of turbulators that trip the boundary layer into turbulance and/or flappers that impart a pulsation motion to the fuel/air mixture and may also disrupt the boundary layer. In this manner, a perturbation effect is imparted to a fuel/air mixture passing through injection nozzle assembly 39 prior to being released into combustion chamber 48 and ignited. The perturbation effect within injection nozzle assembly 39 and disruption/alteration of boundary layer and associated vortex structure in combustor 48 results in a decoupling of combustion and acoustic components of the combustion process in order to suppress combustion screech in turbomachine 2.

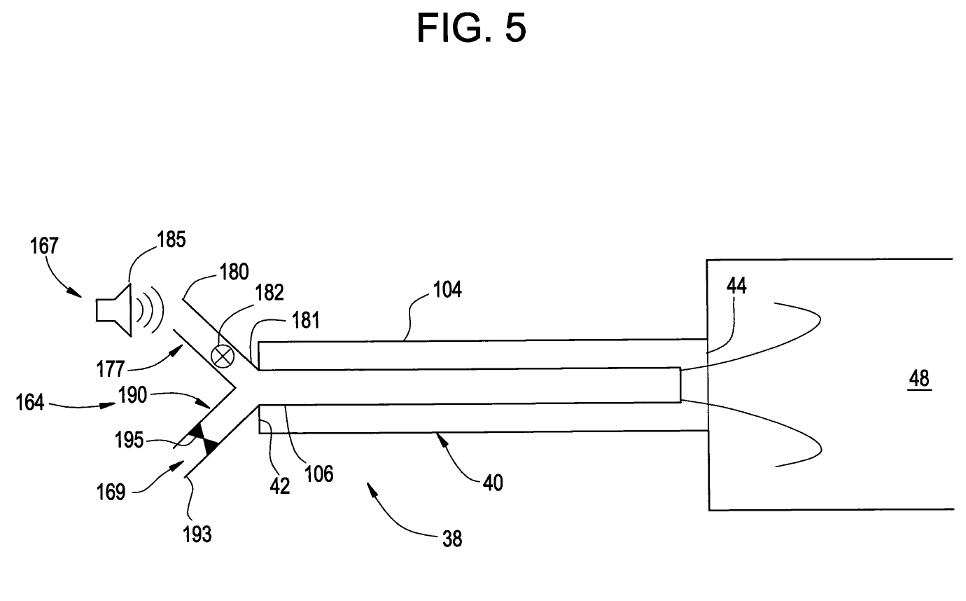

Reference will now be made to FIG. 5, wherein like reference numbers represent corresponding parts in the separate views, in describing a combustion dynamics reduction system 164 constructed in accordance with yet another embodiment of the invention. As shown, combustion dynamics reduction system 164 includes an acoustic wave introduction system 167 and a fluid introduction system 169. More specifically, acoustic wave introduction system 167 includes a first input line 177 having a first end 180 that extends to a second end 181. Second end 181 is fluidly connected to first end portion 42 of injection nozzle assembly 38. A valve 182 is positioned within first input line 177 to control introduction of an acoustic wave that is delivered into injection nozzle assembly 38. More specifically, acoustic wave introduction system 167 includes an acoustic driver 185 that is positioned at first end 180 of first input line 177. In a manner that will be described more fully below, acoustic driver 185 is selectively operated to deliver acoustic waves at various frequencies to a base of the flame present at injection nozzle assembly 38.

As further shown in FIG. 5, fluid introduction system 169 includes a second input line 190 having a first end 193 that extends to a second end 194. In a manner similar to that described above, second end 194 is fluidly connected to first end portion 42 of injection nozzle assembly 38. Second input line 190 includes a valve 195 that controls the introduction of a fluid, such as air, fuel, and/or diluents, into injection nozzle assembly 38. With this arrangement an acoustic wave and/or air/fuel/diluent or mixture thereof is introduced into injection nozzle assembly 38 and directed at a base portion of the flame within combustion chamber 48. The introduction of the acoustic wave and/or fluid decouples the acoustic component and the combustion field component in order to suppress combustion screech within turbomachine 2. More specifically, acoustic driver 185 is operated to change both frequency and amplitude of an acoustic wave passing into injection nozzle assembly 38 in order to perturb or disrupt the base of the flame within combustion chamber 48. Likewise, air can also be injected into injection nozzle assembly 38 to further impact the base of the flame and associated boundary layer and vortex characteristics. This alters the response of the combustion component and de-couples the combustion component from the acoustic component.

At this point it should be understood that the present invention provides a system for suppressing combustion screech in a turbomachine by creating a boundary layer disruption within injection nozzles associated with a particular combustor or providing a system to disrupt a base portion of the flame directly at an exit of a particular injection nozzle. By creating time varying changes within the injection nozzle assemblies, combustion screech can be significantly reduced if not eliminated. Furthermore, eliminating combustion screech in this manner allows operators to take advantage of all turbomachine operating ranges. In addition, by suppressing combustion screech at the source, i.e. within the nozzle assembly and/or combustion chamber, and development of a high frequency dynamic field is eliminated before having a chance to propagate through turbomachine components.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a combustion chamber;
at least one pre-mixer mounted to the combustion chamber, the at least one pre-mixer including a main body including a first end portion that extends to a second end portion, the first end portion being configured to receive an amount of fuel and an amount of air and the second end portion defining an exit plane from which a fuel-air mixture discharges into the combustion chamber; and
a combustion dynamics reduction system operatively coupled to the at least one pre-mixer, the combustion dynamics reduction system including at least one of a boundary layer perturbation mechanism and an acoustic wave introduction system that disrupt a flow pattern of the fuel-air mixture within the at least one pre-mixer.

2. The turbomachine according to claim 1, wherein the combustion dynamics reduction system includes a boundary layer perturbation mechanism, the boundary layer perturbation mechanism including one of an air/inert injection system operatively coupled to the pre-mixer and mechanical member mounted in the at least one pre-mixer.

3. The turbomachine according to claim 2, wherein the boundary layer perturbation mechanism includes an air/inert injection system, the air/inert injection system including an inlet for receiving an amount of air/inert and an outlet for releasing the amount of air/inert.

4. The turbomachine according to claim 3, wherein the outlet is positioned in the pre-mixer.

5. The turbomachine according to claim 4, wherein the outlet is positioned adjacent the exit plane.

6. The turbomachine according to claim 2, wherein the boundary layer perturbation system includes a mechanical member mounted in the pre-mixer.

7. The turbomachine according to claim 6, wherein the mechanical member comprises at least one protrusion mounted in the pre-mixer, the at least one protrusion modifying the flow pattern of the fuel-air mixture.

8. The turbomachine according to claim 7, wherein the at least one protrusion is mounted adjacent the exit plane.

9. The turbomachine according to claim 1, wherein the combustion dynamics reduction system comprises an acoustic wave introduction system, the acoustic wave introduction system including an acoustic driver operatively connected to the at least one pre-mixer.

10. The turbomachine according to claim 9, wherein the combustion dynamics reduction system includes a fluid introduction system, the fluid introduction system being operatively connected to the at least one pre-mixer.

11. A method of reducing combustion dynamics in a turbomachine comprising:
directing a fuel-air mixture through a pre-mixer into a combustion chamber, the pre-mixer; and
reducing combustion dynamics by disrupting a flow pattern of the fuel-air mixture within the at least one pre-mixer.

12. The method of claim 11, wherein reducing combustion dynamics comprises perturbing a boundary layer of the fuel-air mixture passing from the pre-mixer.

13. The method of claim 12, wherein perturbing a boundary layer of the fuel-air mixture comprises injecting air into the fuel-air mixture at an exit plane of the pre-mixer.

14. The method of claim 12, wherein perturbing a boundary layer of the fuel-air mixture comprises passing the fuel-air mixture over at least one mechanical member arranged in the pre-mixer.

15. The method of claim 14, wherein passing the fuel-air mixture over at least one mechanical member arranged in the pre-mixer comprises passing the fuel-air mixture over at least one protrusion mounted in the pre-mixer, the at least one protrusion modifying a flow pattern of the fuel-air mixture.

16. The method of claim 15, wherein passing the fuel-air mixture over at least one protrusion comprises passing the fuel-air mixture over the at least one protrusion arranged at an exit plane of the pre-mixer.

17. The method of claim 11, wherein reducing combustion dynamics comprises perturbing a base portion of a flame at an exit plane of the pre-mixer.

18. The method of claim 17, wherein perturbing the base portion of the flame comprises introducing an acoustic wave into the pre-mixer.

19. The method of claim 18, wherein introducing the acoustic wave into the pre-mixer comprises varying a frequency of the acoustic wave.

20. The method of claim 18, further comprising:
introducing a fluid into the pre-mixing to further perturb the base portion of the flame.
